(19) United States
(12) Patent Application Publication
(10) Pub. No.: US 2021/0231246 A1
(43) Pub. Date: Jul. 29, 2021

(54) SYSTEM AND METHOD FOR REDUCING ENVIRONMENTAL IMPACT CAUSED BY HYDRAULIC OIL LEAKING FROM A TRACTOR

(71) Applicant: Scott Grove, New Hampton, IA (US)

(72) Inventor: Scott Grove, New Hampton, IA (US)

(21) Appl. No.: 17/209,889

(22) Filed: Mar. 23, 2021

Related U.S. Application Data
(63) Continuation-in-part of application No. 16/921,864, filed on Jul. 6, 2020.
Application No. 16/921,864 is a division of application No. 15/908,280, filed on Feb. 28, 2018, now Pat. No. 10,760,725.
(60) Provisional application No. 62/466,178, filed on Mar. 2, 2017.
(60) Provisional application No. 62/993,132, filed on Mar. 23, 2020.

(51) Int. Cl. F16L 37/413; F15B 13/01; B23P 19/04; F15B 20/00; F16L 37/28

(52) U.S. Cl. CPC F16L 37/413; F15B 13/01; E02F 9/226; F15B 20/005; F16L 37/28; B23P 19/04

(57) ABSTRACT

A method and system for reducing leakage of hydraulic oil from a hydraulic outlet on a tractor, which involves removal of the female quick connect coupler from a legacy original equipment selective control valve and inserting into the void the following: a three part insert with a front stepped diameter segment, a back section, which is screwed into front stepped diameter segment, a sleeve which is configured to be inserted after a front O-ring is adjusted and a leading portion of a retention bolt.

### CROSS REFERENCE TO RELATED APPLICATIONS

This application claims the benefit of the provisional application filed on Mar. 23, 2020 and having Ser. No. 62/993,132; and is a continuation-in-part of the non-provisional application filed Jul. 6, 2020 and having Ser. No. 16/921,864; which application is a divisional of the non-provisional application filed Feb. 28, 2018 and having Ser. No. 15/908,280, which has now issued on Sep. 1, 2020 as U.S. Pat. No. 10,760,725; which application claims the benefit of provisional application filed on Mar. 2, 2017 and having Ser. No. 62/466,178; by the same inventor, which are hereby incorporated herein in their entirety by this reference.

### FIELD OF THE INVENTION

The present invention generally relates to tractors, and more specifically to tractors with hydraulic outlets for providing hydraulic power to implements which utilize hydraulic power for operation, and even more specifically relates to hydraulic outlets which have internally integrated female quick connect couplers.

### BACKGROUND OF THE INVENTION

In the past, many tractors have provided a hydraulic outlet for use by implements which use hydraulic power for operation. Typically, these hydraulic outlets accept hoses from implements to couple through standardized quick connect couplers. Depending upon the nature of the particular needs and applications, these outlets may be coupled and uncoupled several times a day or more.

While these hydraulic outlets have successfully provided hydraulic power to many implements, in some instances these hydraulic outlets begin to leak hydraulic oil and result in contamination of the soil by exposure to hydraulic oil and therefore need to be serviced and/or be rebuilt frequently, often at a cost of hundreds of dollars per service event.

Consequently, there exists a need for improved environmentally friendly methods and systems for providing sources of hydraulic power to implements which are more robust and dramatically decrease leakage of hydraulic oil and the concomitant need to repair or rebuild the hydraulic outlet.

### SUMMARY OF THE INVENTION

It is an object of the present invention to provide an environmentally friendly system for coupling hydraulic hoses into a tractor's hydraulic outlet which decrease pollution and decreases the mean time between servicing of the hydraulic outlet.

It is a feature of the present invention to utilize an adjustable semi-permanent hydraulic outlet insert, having an adjustable outside diameter characteristic, which is configured to easily fit inside a legacy hydraulic outlet opening and be expanded once inserted.

It is an advantage of the present invention to reduce the amount of leakage of hydraulic oil and frequency of the need to repair and/or rebuild the tractor's hydraulic outlet.

It is another object of the present invention to reduce the cost of replacing a female quick connect coupler which is associated with the hydraulic outlet and of the type configured to accept hoses with a male quick connect coupler attached thereto.

It is another feature of the present invention to provide a screw-in commercial off-the-shelf female quick connect coupler which is configured to screw into an exposed end of the semi-permanent hydraulic outlet insert.

It is another advantage of the present invention to allow for dramatic reduction in cost of replacing the wear parts of a female quick connect coupler.

The present invention is a system and method for reducing: leakage of hydraulic oil, a need to repair and/or rebuild hydraulic outlets on tractors and the cost of making such repairs.

Accordingly, the present invention is a method of reducing soil contamination caused by infiltration of hydraulic oil leaking from a tractor, comprising the steps of:
provide a selective control valve for provisioning hydraulic oil under pressure and having a first coupler orifice therein and a second coupler orifice therein; said first coupler orifice having a first quick release mechanism disposed therein;
remove a snap ring exposing said first quick release mechanism;
remove a barrel from said first coupler orifice;
insert through said first coupler orifice, an insert having an insert maximum diameter portion, intermediate diameter portion a smaller than intermediate diameter portion and an interior back face;
install a retention bolt through a washer into an internally threaded portion of said smaller than intermediate diameter portion at said interior back face; and
tighten said retention bolt, thereby causing said insert to move further into said selective control valve.

Additionally, the present invention is a system for reducing leakage of hydraulic oil from a legacy original equipment selective control valve comprising:
a front stepped diameter portion with: a fluid channel therethrough, a face orifice therein, a front stepped diameter portion longitudinal axis, and a portion of said front stepped diameter portion being sized and configured to be inserted in a coupler orifice in a selective control valve;
a back portion with a back portion longitudinal axis, said back portion, having an oil receiving orifice extending through said back portion transverse to the back portion longitudinal axis;
the face orifice being in fluid communication with the oil receiving orifice;
a first O-ring disposed about said back portion longitudinal axis; and
a threaded retention fastener configured to rotatably mate with a threaded interior portion of said back portion, and configured to cause retention of said front stepped diameter portion with respect to the selective control valve, when said threaded retention fastener is advanced into said threaded interior portion of said back portion.

### BRIEF DESCRIPTION OF THE DRAWINGS

The invention may be more fully understood by reading the foregoing description of the preferred embodiments of the invention, in conjunction with the appended drawing wherein:

FIG. 1 is a pictorial representation of the prior art.

FIG. 2 is a pictorial representation of a side view of the present invention.

FIG. 3 is an exploded perspective view of the present invention.

FIG. 4 is another exploded perspective view of the present invention from a perspective different from FIG. 3.

FIG. 5 is an exploded perspective view of the present invention in combination with components well known in the prior art.

FIG. 6 is a side view of the front stepped diameter segment 200A of FIG. 3.

FIG. 7 is a cross-sectional view of the front stepped diameter segment 200A of FIG. 6.

FIG. 8 is a side view of the back section 200B of FIG. 3.

FIG. 9 is an alternate view of the back section 200B from a different perspective from FIG. 3.

FIG. 10 is a side view cutaway of the prior art.

FIG. 11 is a side view of alternate embodiment of the present invention with a solid O-ring less insert for John Deere years 1964 through 1982.

FIG. 12 is a side view of alternate embodiment of the present invention with a solid O-ring less insert for John Deere years 1983 through 1996.

### DETAILED DESCRIPTION

Although described with particular reference to tractors, the systems and methods of the present invention can be implemented in many different ways and with different types of systems and for different purposes, the embodiments described herein are merely examples of the many possible variations.

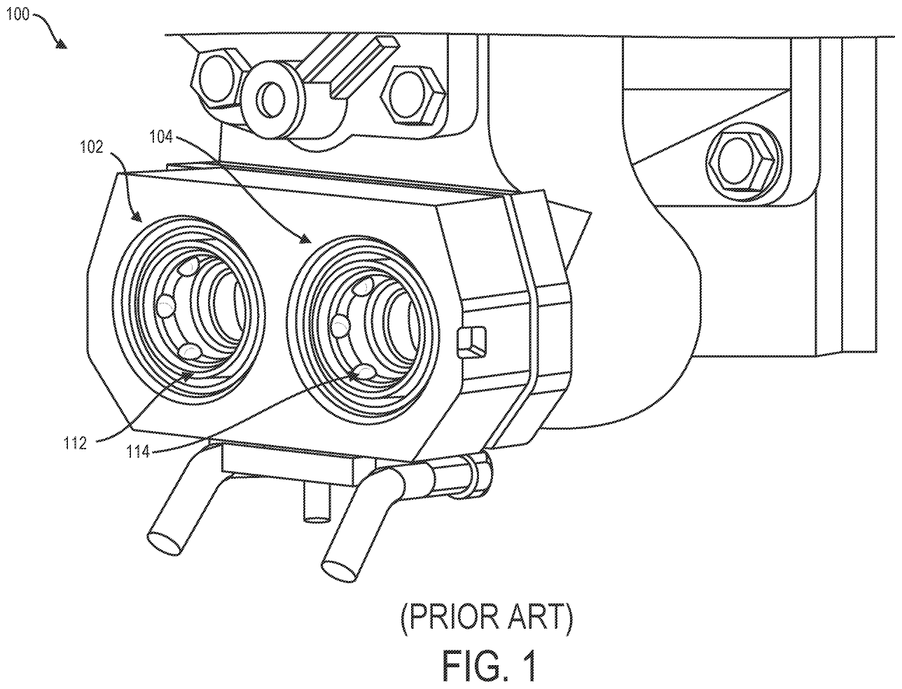

Now referring to the drawings wherein like numerals refer to like matter throughout, there is shown in FIG. 1 a representation of the prior art. The term “legacy original equipment selective control valve” is hereby defined to mean: an original equipment selective control valve of the type that was standard equipment on tractors made by Deere and Company of Moline Ill. during the years 1964 through 1982. FIG. 1 shows a legacy original equipment selective control valve 100. During the years 1961-1963, 1983 through 1994, minor dimensional differences occurred in these SCVs, however, the present invention can be readily adapted to function for such additional years. The legacy original equipment selective control valve 100 contains a first OEM quick release mechanism 112 which fits in first coupler orifice 102 and a second OEM quick release mechanism 114 which fits in second coupler orifice 104. Both first OEM quick release mechanism 112 and second OEM quick release mechanism 114 need to be removed to allow for insertion of the present invention.

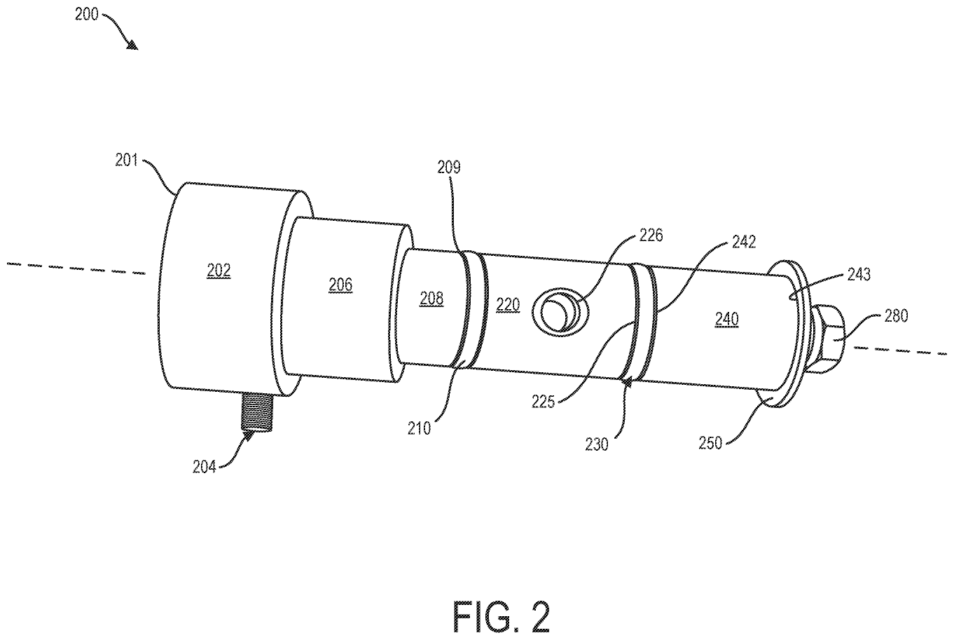

Now referring to FIG. 2, there is shown an assembled view of the insert assembly 200 of the present invention. Insert assembly 200 is designed to be inserted to either first coupler orifice 102 or second coupler orifice 104. All of the components of insert assembly 200 are inserted into the front opening of first coupler orifice 102 as shown in FIG. 1, except for the retention bolt 280, lock washer 270, intermediate washer 260 and large washer 250. Insert assembly 200 is shown with an insert exterior face 201, insert maximum diameter portion 202, intermediate diameter portion 206 and minimum diameter portion 208, which are all made from a single machined piece of metal. Any suitable metal may be used, but stainless steel may be the preferred material. Insert maximum diameter portion 202 is shown with an indexing protuberance screw 204 disposed in an indexing protuberance screw threaded hole 205 therein. Indexing screw 204 is used to assure the proper orientation of the front stepped diameter segment 200A when it is inserted into first coupler orifice 102 or second coupler orifice 104. Alternate designs of a mechanism for indexing could be used, including a protuberance integrated with the insert maximum diameter portion 202. Intermediate diameter portion 206 of front stepped diameter segment 200A is configured to fit in a segment of the first coupler orifice 102 or second coupler orifice 104. Minimum diameter portion 208, at the point of opposing face 209, is substantially similar in diameter to interior section 220 of back section 200B, which also contains interior front face 221, front unthreaded section 222, and threaded section 223. Back section 200B includes interior section 220 with an oil receiving orifice 226. Back O-ring mating face 225 corresponds to the opposing face 209 of front stepped diameter segment 200A. Front O-ring 210 is disposed between front stepped diameter segment 200A and back section 200B at the opposing face 209. Similarly, back O-ring 230 is disposed between back section 200B at its back O-ring mating face 225, and sleeve front face tapered transition 242 of sleeve 240 of back section sleeve 200C, which has a sleeve back face 243.

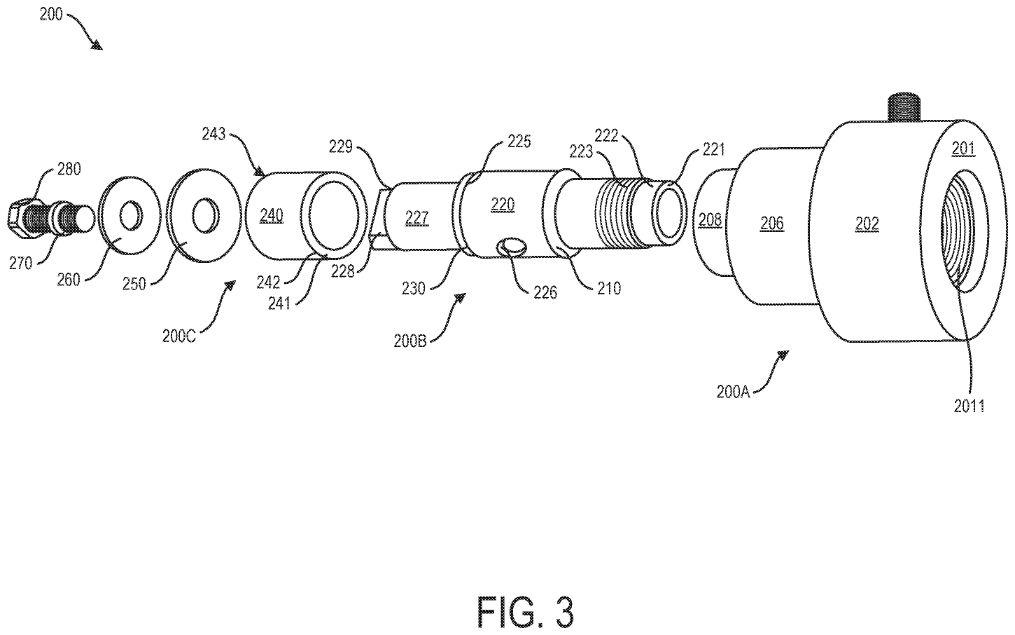

Now referring to FIG. 3, there is shown back section 200B which includes back portion 227, back flat face portion 228 and interior back face 229. Back flat face portion 228 is used to facilitate turning the back section 200B, with a wrench or other suitable tool, when it is being screwed into front stepped diameter segment 200A. The diameter of front O-ring 210 can be adjusted by opening and closing the gap between opposing face 209 and the leading face the maximum diameter portion of interior section 220.

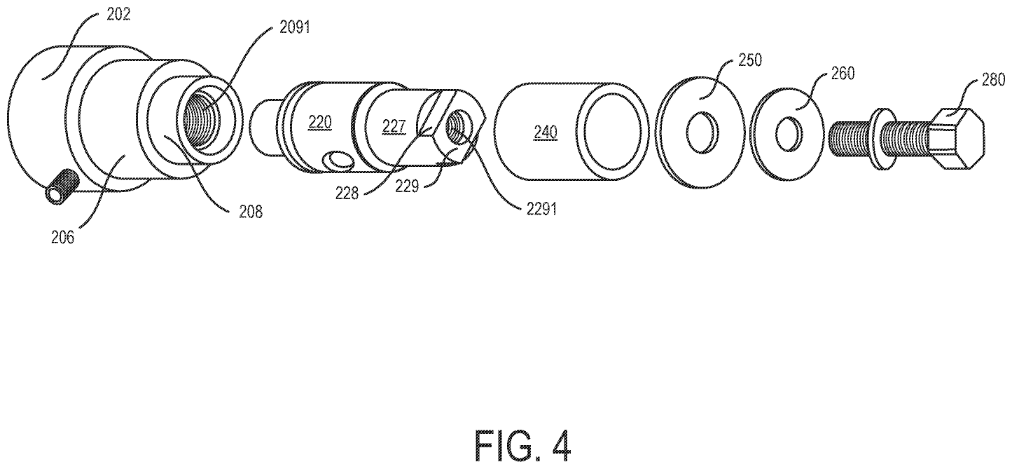

Now referring to FIG. 4, which shows the insert assembly 200 in exploded views, but from different perspectives. The diameter of back O-ring 230 can be adjusted by tightening the retention bolt 280 into the threaded internal portion of interior back face 229 when the sleeve 240 is disposed about the unthreaded back portion 227 and while large washer 250, and optionally intermediate washer 260, and lock washer 270 are properly connected.

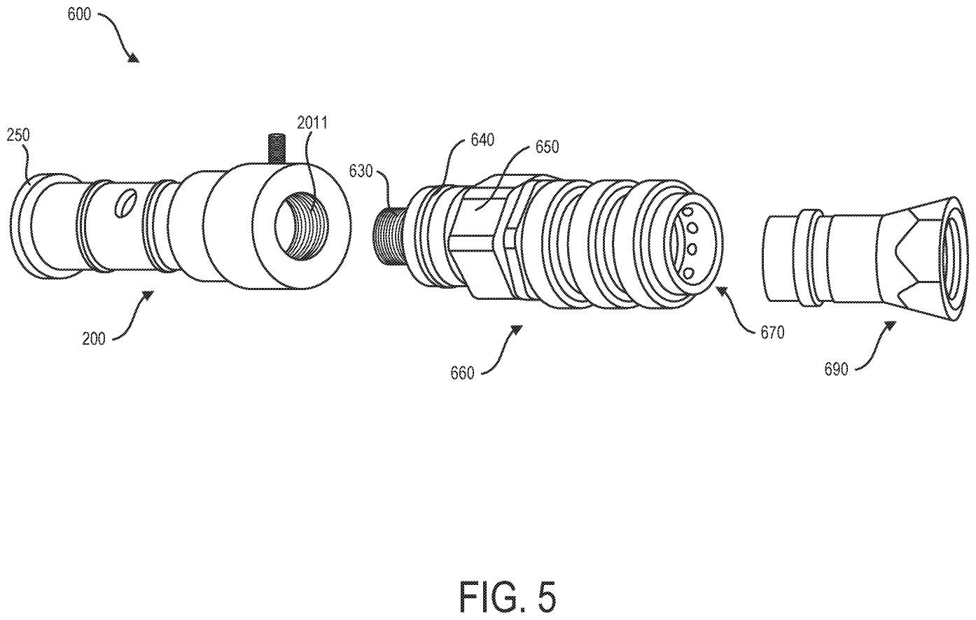

Now referring to FIG. 5, there is shown an exploded view of the present invention exploded assembly 600, with insert assembly 200 of the present invention in combination with prior devices, such as quick release coupler 660 with its quick release female end 670 and with attached hexagonal wrench mating section 650, threaded rear mating section O-ring 640, and threaded rear mating section 630, which is configured to mate with the threads in the front portion of insert maximum diameter portion 202.

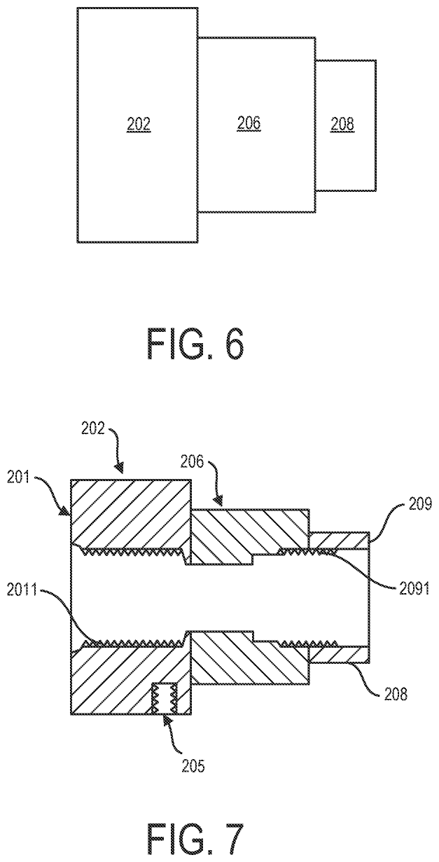

Now referring to FIG. 6, there is shown a side view of the front stepped diameter segment 200A with dimensions which may represent a best mode of the present invention.

Now referring to FIG. 7, there is shown a cross-sectional view of the front stepped diameter segment 200A of FIG. 6, which includes; an internal face threaded portion 2011 and a minimum diameter portion internal threading 2091.

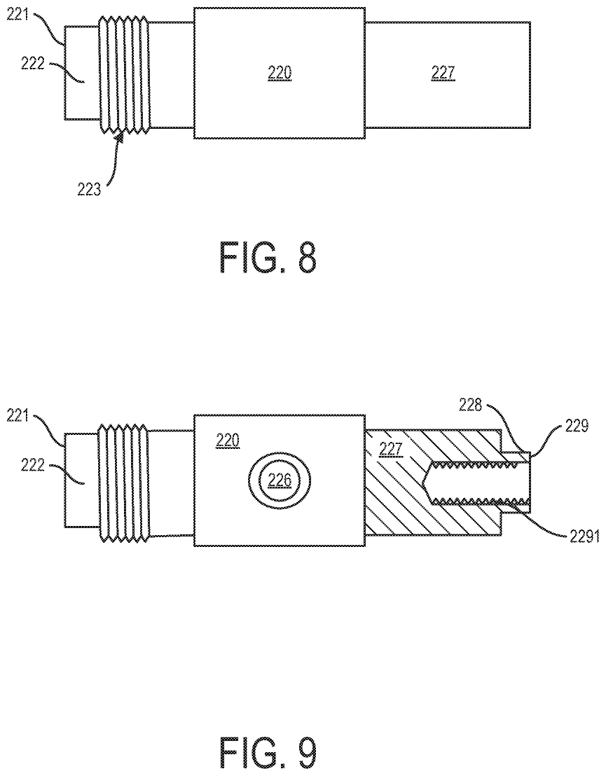

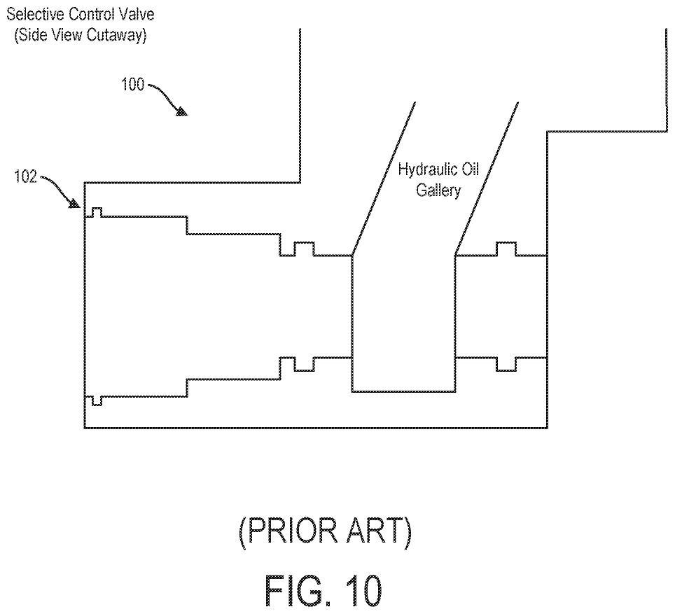

Now referring to FIG. 8, there is shown a side view of the back section 200B of the present invention (without back flat face portion 228) being shown.

Now referring to FIG. 9, there is shown an alternate view of the back section 200B from a different perspective. Note that a portion is shown in cut-away view, which shows internally threaded back face void 2291.

The method of installing the apparatus described above is as follows:

Before starting job, remember to park machine safely, lower all equipment to the ground, put in park/set parking brake, stop the engine and remove the key, work in clean area, clean work area and machine, make sure you have all necessary tools to do the job, read all instructions thoroughly, do not attempt shortcuts, and clean valve area thoroughly, front and rear, prior to disassembly.

STEP 1. Remove OEM snap rings.

a. Remove and retain snap rings.

STEP 2. Remove expansion plugs.

a. Remove expansion plugs from the top of the valve body.

b. Use a sharp punch and hammer.

STEP 3. Remove e-clips and springs.
a. Remove e-clips and springs from coupler barrel levers located under expansion plugs.
b. Discard e-clips, springs, and levers, new parts are provided with kit.
c. Remove barrels from SCV housing.

STEP 4. Remove OEM O-rings and backers.
a. Remove OEM O-rings and backers from SCV bore using a long O-ring pick.
b. Two O-rings and two backers per bore.

STEP 5. Clean SCV bore.
a. This step is very important as damage to new O-rings may occur if this step is neglected.
b. Brake and parts cleaner is recommended.
c. Blow dry with compressed air once debris is washed away.

STEP 6. Inspect valve body bore face.
a. Assure that no damage has occurred to valve body bore face.
b. If damage is visible, use rat tail file or a half round file to smooth the surfaces.
c. If a file is used, repeat step 5.

STEP 7. Remove insert assembly 200 from package.
a. Remove 5/16″ cap screw, i.e. retention bolt 280, and washer from the rear half of the insert assembly 200.
b. Remove O-ring expansion sleeve 240.
c. Apply grease or assembly lube liberally to front O-ring 210 and back O-ring 230.

STEP 8. Install insert assembly 200 into valve body through one of first coupler orifice 102 and second coupler orifice 104.
a. Gently install insert assembly 200 into valve body, making sure indexing screw 204 on the front half of the insert assembly 200 is in the 12 o'clock position (light tapping may be required).
b. Use a rubber mallet to reduce risk of damage.
c. (DO NOT FORCE) O-ring damage may result.
d. When insert assembly 200 is firmly seated, install OEM snap ring into the valve body.

STEP 9. Install aftermarket hydraulic couplers.
a. Breakaway coupler/quick release coupler 660 included in kit, tighten with open end wrench.
b. Damage to valve body may result in the event of implement breakaway if these couplers are not used.
c. Rotate insert and coupler assembly by hand counter clockwise until it stops.

STEP 10. Tighten Insert.
a. Using a ⅝″ open end wrench, tighten the rear half of the insert firmly at back flat face portion 228 of interior back face 229.
b. Install the compression sleeve 240 onto the rear half of the insert assembly 200.
c. Install the 5/16″ cap screw/retention bolt 280, flat washer, large washer 250 and lock washer using a ½″ box end wrench and tighten firmly.

STEP 11. Install supplied expansion plugs.
a. Install expansion plugs onto the top of the valve using a hammer and a punch.

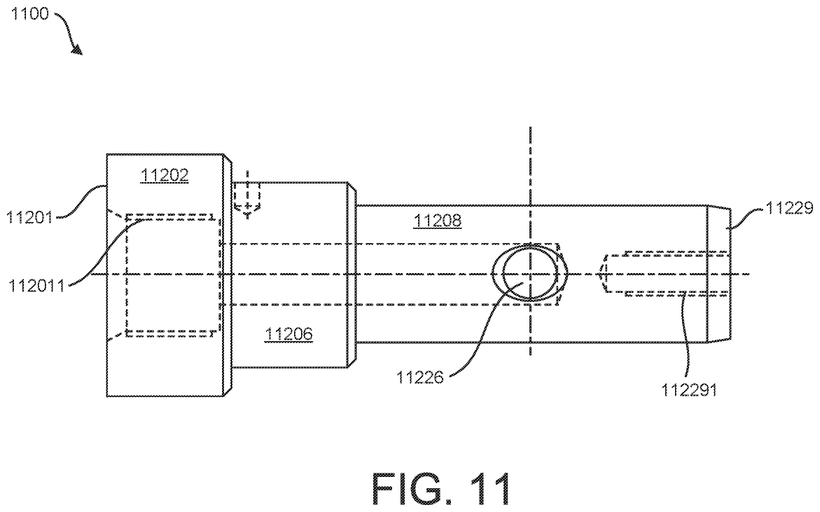

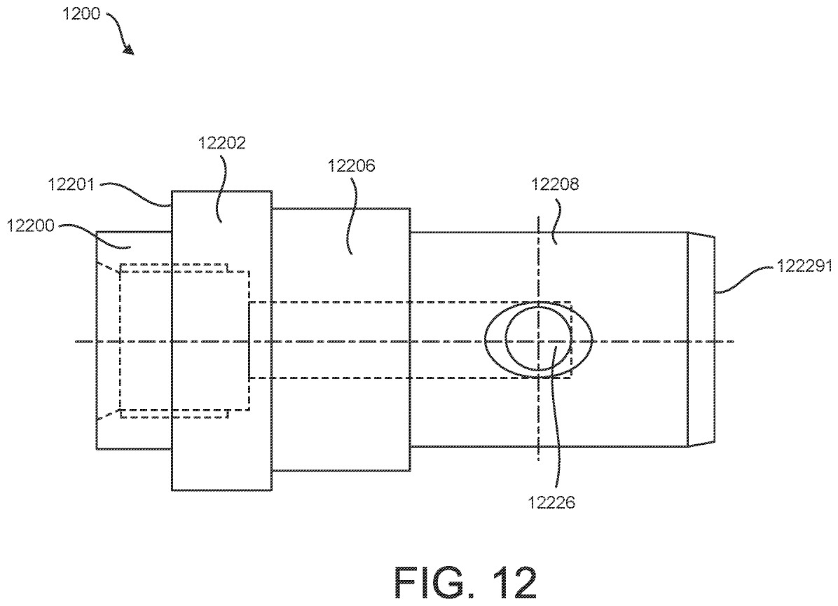

### The Solid Insert Improvement is Shown in FIGS. 11-12 and Discussed Below.

The method of the solid insert or (single piece) insert invention is very similar to the method for the method and system described above with respect to FIGS. 2-9, except that the insert with two internal O-rings as shown in FIGS. 2-4 is replaced with the O-ring less insert shown in FIGS. 11 and 12. The method is the same except that the step of removing the O-rings as described above in the method with the insert of FIGS. 2-4, is not essential, however, if it is done and it may be desired to remove the O-ring, but then they MUST be replaced with presumably newer and better O-rings. Then the insertion of the insert of FIGS. 11 and 12 can be performed. One benefit of this embodiment is that the insert shown in FIGS. 11 and 12 is much less expensive to make compared to the insert in FIGS. 2-9.

It is thought that the method and apparatus of the present invention will be understood from the foregoing description and that it will be apparent that various changes may be made in the form, construct steps and arrangement of the parts and steps thereof without departing from the spirit and scope of the invention or sacrificing all of their material advantages. The form herein described is merely a preferred exemplary embodiment thereof

I claim:

1. A method of reducing environmental soil contamination caused by infiltration of hydraulic oil leaking from a tractor, comprising the steps of:
provide a selective control valve for provisioning hydraulic oil under pressure and having a first coupler orifice therein and a second coupler orifice therein; said first coupler orifice having a first quick release mechanism disposed therein;
remove a snap ring exposing said first quick release mechanism;
remove a barrel from said first coupler orifice;
insert through said first coupler orifice, an insert having an insert maximum diameter portion, intermediate diameter portion a smaller than intermediate diameter portion and an interior back face;
install a retention bolt through a washer into an internally threaded portion of said smaller than intermediate diameter portion at said interior back face; and
tighten said retention bolt, thereby causing said insert to move further into said selective control valve.

2. The method of claim 1 wherein said selective control valve is an original equipment selective control valve.

3. The method of claim 1 wherein said washer has a larger outside diameter than said interior back face.

4. The method of claim 3 wherein said smaller than intermediate diameter portion has a cylindrical exterior surface.

5. The method of claim 4 wherein one of said smaller than intermediate diameter portion and said intermediate diameter portion has an oil receiving orifice therein.

6. The method of claim 5 wherein said oil receiving portion is located in said smaller than intermediate diameter portion.

7. The method of claim 6 where said insert is inserted into the selective control valve having a first O-ring and a second O-ring therein, and the interior back face passes through the first O-ring and then the second O-ring before encountering the washer.

8. The method of claim 7 wherein said oil receiving orifice passes the first O-ring but never passes the second O-ring.

9. The method of claim 8 wherein said intermediate diameter portion does not pass either the first O-ring or the second O-ring.

10. The method of claim 9 wherein one of said insert maximum diameter portion (202) and said intermediate diameter portion (206) has an indexing protuberance extending externally therefrom.

11. A system for reducing leakage of hydraulic oil from a legacy original equipment selective control valve comprising:
a front stepped diameter portion with: a fluid channel therethrough, a face orifice therein, a front stepped diameter portion longitudinal axis, and a portion of said front stepped diameter portion being sized and configured to be inserted in a coupler orifice in a selective control valve;
a back portion with a back portion longitudinal axis, said back portion, having an oil receiving orifice extending through said back portion transverse to the back portion longitudinal axis;
the face orifice being in fluid communication with the oil receiving orifice;
a first O-ring disposed about said back portion longitudinal axis; and
a threaded retention fastener configured to rotatably mate with a threaded interior portion of said back portion, and configured to cause retention of said front stepped diameter portion with respect to the selective control valve, when said threaded retention fastener is advanced into said threaded interior portion of said back portion.

12. The system of claim 11 wherein said front stepped diameter portion and said back portion are separate and distinct objects which are caused to mate with each other to form an assembly designed to be inserted into a coupler orifice of the selective control valve.

13. The system of claim 11 wherein said front stepped diameter portion and said back portion are not a single piece of machined metal.

14. The system of claim 11 wherein said first O-ring is further disposed between and captured by an area of said first stepped diameter portion and an area of said back portion.

15. The system of claim 11 wherein said front stepped diameter portion and said back portion are separate areas of a single piece of machined metal.

16. The system of claim 11 wherein said first O-ring is captured within the selective control valve and is disposed about the back portion longitudinal axis only after the back portion has been inserted into the selective control valve.

17. A system for reducing leakage of hydraulic oil comprising:
a portion of a selective control valve after having removed therefrom, a first quick release mechanism from a first coupler orifice therein;
a front portion with an insert maximum diameter characteristic, with an insert exterior face;
a back portion with an interior section having an oil receiving orifice therein;
a front O-ring disposed between the insert exterior face and the oil receiving orifice; and
a back O-ring is disposed between said oil receiving orifice and a back portion terminal end.

18. The system of claim 17 wherein said front O-ring is further disposed between and captured by an area of said first stepped diameter portion and an area of said back portion.

19. The system of claim 17 wherein said front O-ring is captured by an area of said selective control valve.

20. The system of claim 17 wherein said front stepped diameter portion and said back portion are separate areas of a single piece of machined metal.
